(19) United States
(12) Patent Application Publication
(10) Pub. No.: US 2010/0216965 A1
(43) Pub. Date: Aug. 26, 2010

(54) THERMOPLASTIC NANOPARTICLES, METHOD FOR PRODUCTION AND USE THEREOF

(75) Inventors: Andreas Poppe, Sendenhorst (DE); Elke Westhoff, Steinfurt (DE); Ralf Nickolaus, Drensteinfurt (DE); Rolf Boysen, Munster (DE)

Correspondence Address: Mary E. Golota;Cantor Colburn LLP, 201 W. Big Beaver Road, Suite 1101, Troy, MI, 48084, US

(73) Assignee: BASF COATINGS AKTIENGESELLSCHAFT, Munster (DE)

(21) Appl. No.: 12/066,298

(22) PCT Filed: Sep. 7, 2006
(86) PCT No.: PCT/EP06/08733

§ 371 Date: Mar. 10, 2008

(30) Foreign Application Priority Data
Sep. 10, 2005 (DE) 10 2005 043 073.2

(51) Int. Cl. C08G 77/04

(52) U.S. Cl. 528/27

(57) ABSTRACT

Disclosed herein are thermoplastic nanoparticles with a glass transition temperature of 30 to 120° C. prepared by hydrolysis and condensation of a compound (Ia) (D-K—X—)ₘA{—X—K[—B(—Y)ₙ]ₚ}_{q} or (Ib) (D-K—X—)ₘB{—X—K[-A(—Y)ₙ]ₚ}_{q} (Ib) where m is 1 to 5; n is 1 to 3; p is 1 or 2; q is 1 to 5; A is a hardening structural element which; B is a softening, flexibilizing structural element; D is the radical of a blocking agent for isocyanate groups —NCZ, in which Z=oxygen or sulfur atom; X is a group of the general formula (II) —NH—C(Z)—; K is a divalent or trivalent atom or divalent or trivalent linking functional group; Y is a group of the general formula (III) —SiEᵣF₃₋ᵣ, where r is 1 to 3; E is a hydrolyzable atom or radical, and F is a nonhydrolyzable radical; processes for preparing them, and their use.

### FIELD OF THE INVENTION

The present invention relates to new thermoplastic nanoparticles. The present invention also relates to a new process for preparing thermoplastic nanoparticles. The present invention further relates to the use of the new thermoplastic nanoparticles and of the thermoplastic nanoparticles prepared by the new process for preparing new thermoplastic and/or curable materials.

### PRIOR ART

Nanoparticles, such as colloidal metal oxides, whose surface has been modified with a modifier of the general formula:

Q-NH—C(O)—NR—(—CH₂—)ₙ—SiXYZ,

are known from the American patent U.S. Pat. No. 5,998,504. In the general formula the index n stands for 2, 3 or 4. The radical R stands for hydrogen or an organic radical having 1 to 40 carbon atoms. The radicals X, Y and Z stand for hydrolyzable alkoxy groups having 1 to 4 carbon atoms. The radical Q stands for an organic radical having at least one blocked isocyanate group, and can be an aliphatic, cycloaliphatic or aromatic group.

The known, modified nanoparticles can be used as such or in combination with compounds containing at least two isocyanate-reactive functional groups to produce scratch-resistant coatings. These coatings are composed in the main of the metal oxides.

The use of the known, modified nanoparticles as functional additives, which are added in comparatively small and hence particularly economic amounts to thermoplastic and/or curable materials, especially thermally curable coating materials, is not apparent from the American patent.

Thermoplastic and/or thermally curable coating materials, such as powder clearcoat materials, have been known for some time (cf., e.g., the BASF Coatings AG company brochures “Pulverlacke für industrielle Anwendungen”, January 2000, or “Coatings Partner, Pulverlack Spezial”, 1/2000; and Römpp Lexikon Lacke and Druckfarben, Georg Thieme Verlag, Stuttgart, N.Y., 1998, pages 187 and 188, “powder coating materials”, “powder coating”, and “powder coating equipment”). The clearcoats produced from them, in spite of numerous technical advantages, are nevertheless inferior in their scratch resistance to the clearcoats produced from conventional or aqueous clearcoat materials.

Powder clearcoat materials, however, have the substantial technical advantage that they can be prepared, handled, applied, and cured without the use of organic solvents or water. In contrast, removing the organic solvents or the water from the conventional or aqueous clearcoat materials in the course of their curing necessitates expending a high level of energy. A further factor is the safety problems associated with the use of organic solvents. Not least, the overspray produced when powder coating materials are applied is much easier to recover than the overspray from conventional or aqueous clearcoat materials.

It would therefore be highly desirable to have available powder clearcoat materials which give clearcoats with a high scratch resistance, without losing the substantial advantages of powder clearcoat materials and clearcoats produced from them.

### Problem

It is an object of the present invention to provide new nanoparticles which can be prepared easily and very reproducibly.

The new nanoparticles ought to be particularly easy to incorporate homogeneously into thermoplastic and/or curable materials.

At the same time they ought to develop their technical advantages in comparatively small amounts, so that they can be used as functional additives in thermoplastic and/or curable materials, particularly in solvent-free and water-free materials.

The thermoplastic and/or curable materials equipped accordingly ought to give thermoplastic or thermoset moldings, sheets, coatings, adhesive layers, and seals, especially coatings, particularly clearcoats, which have, in particular, a high scratch resistance. At the same time they should also be hard, flexible, chemically resistant, solvent resistant, gasoline resistant, stable to weathering, to etching, and to yellowing, should be clear and of high gloss, and should have a high distinctiveness of image (DOI).

### Solution

Found accordingly have been the new thermoplastic nanoparticles with a glass transition temperature of 30 to 120° C., preparable by hydrolysis and condensation of at least one compound selected from the group consisting of compounds of the general formulae Ia and Ib:

(D-K—X—)ₘA{—X—K[—B(—Y)ₙ]ₚ}_{q} (Ia) and

(D-K—X—)ₘB{—X—K[-A(—Y)ₙ]ₚ}_{q} (Ib)

in which the indices and variables are defined as follows:
m is an integer from 1 to 5;
n is an integer from 1 to 3;
p is 1 or 2;
q is an integer from 1 to 5;
A is an at least divalent hardening structural element which as a constituent of three-dimensional networks raises their glass transition temperature;
B is an at least divalent softening, flexibilizing structural element which as a constituent of three-dimensional networks lowers their glass transition temperature;
D is the radical of a blocking agent for isocyanate groups —NCZ, in which Z=oxygen or sulfur atom;
X is a group of the general formula II:

—NH—C(Z)— (II),
in which Z is as defined above and where the nitrogen atom in the general formula Ia is linked to the structural element A and in the general formula Ib is linked to the structural element B;
K is a divalent or trivalent atom or divalent or trivalent linking functional group selected from the group consisting of —Z—, —NH—, —NJ-, —N<, —N═, —NH—C(Z)—, —NH[—C(Z)—]₂, —NH—C(Z)—NH—, —NH—C(Z)—Z—, —NH—C(Z)—NH—C(Z)Z—, —Z—N═, —Z—NH—C(Z)— and —NH—C(Z)—NH—N═C<,
   in which the variable Z is as defined above and
   the variable J is selected from the group consisting of substituted and unsubstituted, heteroatom-containing and heteroatom-free, aliphatic, cycloaliphatic, aromatic, aliphatic-cycloaliphatic, aliphatic-aromatic, cycloaliphatic-aromatic, and aliphatic-cycloaliphatic-aromatic radicals which contain divalent linking functional groups or are free from such groups,
   the covalent bond symbolized by the left-hand outer hyphen linking the atom or the group K to the carbon atom of the group of the general formula II;
Y is the group of the general formula III:

—SiEᵣF₃₋ᵣ (III),

in which the index and variables are defined as follows:
r is an integer from 1 to 3,
E is a hydrolyzable atom or a monovalent hydrolyzable radical, and
F is a nonhydrolyzable radical.

The new thermoplastic nanoparticles with a glass transition temperature of 30 to 120° C. are referred to below as “nanoparticles of the invention”.

Also found has been the new process for preparing the nanoparticles of the invention, which involves
(1) preparing the compound of the general formula Ia by reacting at least one polyisocyanate of the general formula VIIIa:

A(NCZ)_{m+q} (VIIIa),

with m mol of at least one blocking agent of the general formula IX:

D-K—H (IX),

and with q mol of at least one compound of the general formula Xb:

H—K[—B(—Y)ₙ]ₚ (Xb),

until free isocyanate groups —NCZ are no longer detectable, and
(2) preparing the compound of the general formula Ib by reacting at least one polyisocyanate of the general formula (VIIIb):

B(NCZ)_{m+q} (VIIIb),

with m mol of at least one blocking agent of the general formula (IX):

D-K—H (IX),

and with q mol of at least one compound of the general formula (Xa):

H—K[-A(—Y)ₙ]ₚ (Xa),

until free isocyanate groups —NCZ are no longer detectable;
the indices m and q of the general formulae (VIIIa) and (VIIIb), the indices n and p of the general formulae (Xa) and (Xb), the variable A of the general formulae (VIIIa) and (Xa), the variable B of the general formulae (VIIIb) and (Xb), the variable D of the general formula (IX), the variable Z of the general formulae (VIIIa) and (VIIIb), the variable Y of the general formulae (Xa) and (Xb), and the variable K of the general formulae (IX), (Xa), and (Xb) having the definition indicated in claims 1 to 13,
the covalent bond symbolized by the left-hand outer hyphen linking the atom or the group K of the general formulae (IX), (Xa), and (Xb) to the hydrogen atom.

The new process for preparing the nanoparticles of the invention is referred to below as “process of the invention”.

Further subject matter of the invention will emerge from the description.

### ADVANTAGES OF THE INVENTION

In the light of the prior art it was surprising and unforeseeable for the skilled worker that the object on which the present invention was based could be achieved by means of the nanoparticles of the invention and of the process of the invention.

In particular it was surprising that the nanoparticles of the invention could be prepared particularly easily by means of the process of the invention, the reproducibility being outstanding. Thus different batches of given nanoparticles of the invention exhibited only very slight—that is, not technically relevant—physical deviations from one another, if indeed they exhibited any at all.

The nanoparticles of the invention were particularly easy to incorporate homogeneously into thermoplastic and/or curable materials.

At the same time they developed their technical effects and advantages in comparatively small amounts, and so could be used as functional additives in thermoplastic and/or curable materials, especially in solvent-free and water-free materials.

The thermoplastic and/or curable materials equipped accordingly gave thermoplastic or thermoset moldings, sheets, coatings, adhesive layers, and seals, especially coatings, particularly clearcoats, which were notable in particular for a high scratch resistance. At the same time there were also hard, flexible, chemically resistant, solvent resistant, gasoline resistant, stable to weathering, to etching, and to yellowing, were clear and of high gloss, and had a particularly high distinctiveness of image (DOI).

### DETAILED DESCRIPTION OF THE INVENTION

The nanoparticles of the invention are thermoplastic. This means that above their service temperature they possess a reversible flow transition region within which they can be deformed with supply of heat.

The nanoparticles of the invention have, preferably, particle sizes in the range from 1 nm to 1 μm, more preferably 2 nm to 800 nm, very preferably 3 nm to 500 nm, with very particular preference 4 nm to 200 nm, and in particular 5 nm to 100 nm. The particle size is preferably measured by means of laser diffraction or light scattering.

The particle size distribution of the nanoparticles of the invention may vary very widely. Thus it may be comparatively broad or comparatively narrow. It may also be monomodal or bimodal, or may have a higher modality. With preference the particle size distribution is comparatively narrow and monomodal.

The average particle size d₅₀, i.e., the median figure, as determined by means of laser diffraction or light scattering (cf. Ullmann's Encyclopedia of Industrial Chemistry, 1997, 5th Edition on CD-ROM, WILEY-VCH, Weinheim, N.Y., “Particle Size Analysis and Characterization of a Classification Process”; P. Bowen, Journal of Dispersion Science and Technology, vol. 23, No. 5, 2002, pages 631 to 662, “Particle Size Distribution Measurement from Millimeters to Nanometers and from Rods to Platelets”; Basic Principles of Particle Size Analysis”, Technical Paper by Alan Rawle, Malvern Instruments, Great Britain, 1993; or Artur Goldschmidt and Hans-Joachim Streitberger, BASF-Handbuch Lackiertechnik, Vincentz Verlag, Hanover, 2002, “2.3.3.1 Kenngroöβen des Pigmentes als Rohstoff”, pages 310 to 317, especially FIG. 2.3.53, “Übersicht über die optimalen Messbereiche verschiedener Partikelgröβenbestimmungen”) is preferably >1 nm and <1 μm, more preferably >2 nm and <800 nm, very preferably >3 nm and <500 nm, with very particular preference >4 nm and <200 nm, and especially >5 nm and <100 nm.

The nanoparticles of the invention may have any of a very wide variety of three-dimensional forms, as described for example in Ullmann's Encyclopedia of Industrial Chemistry, 1997, 5th Edition on CD-ROM, WILEY-VCH, Weinheim, N.Y., “Particle Size Analysis and Characterization of a Classification Process”; P. Bowen, Journal of Dispersion Science and Technology, vol. 23, No. 5, 2002, pages 631 to 662, “Particle Size Distribution Measurement from Millimeters to Nanometers and from Rods to Platelets”; or “Basic Principles of Particle Size Analysis”, technical paper by Alan Rawle, Malvern Instruments, Great Britain, 1993. The nanoparticles of the invention are preferably spherical.

The nanoparticles of the invention are preparable by hydrolysis and condensation of at least one, especially one, compound selected from compounds of the general formulae Ia and Ib:

(D-K—X—)ₘA{-X—K[—B(—Y)ₙ]ₚ}_{q} (Ia) and

(D-K—X—)ₘB{-X—K[-A(—Y)ₙ]ₚ}_{q} (Ib).

Preferably they are preparable from at least one, especially one, compound of the general formula Ia.

In the general formulae the definition of the indices is as follows:
m is an integer from 1 to 5, preferably 1 or 2;
n is an integer from 1 to 3, preferably 1 or 2;
p is 1 or 2, preferably 1; and
q is an integer from 1 to 5, preferably 1 or 2.

In the general formulae Ia and Ib the variable A is an at least divalent, preferably divalent or trivalent, hardening structural element which as a constituent of three-dimensional networks raises their glass transition temperature.

The structural element A contains preferably at least one, more preferably at least two, and in particular at least three group(s) a1, which is or are selected from the group consisting of divalent and polyvalent, preferably divalent aromatic and cycloaliphatic groups, or else the structural element A is composed of at least one group a1.

Examples of suitable groups a1 are divalent, aromatic, cycloaliphatic, and aromatic-cycloaliphatic groups,

Examples of highly suitable divalent aromatic groups a1 are substituted, especially methyl-substituted, or unsubstituted aromatic radicals having 6 to 30 carbon atoms in the molecule, such as phen-1,4-, -1,3- or -1,2-ylene, naphth-1,4-, -1,3-, -1,2-, -1,5- or -2,5-ylene, propane-2,2-di(phen-4′-yl), methanedi(phen-4′-yl), biphenyl-4,4′-diyl or 2,4- or 2,6-tolylene.

Examples of highly suitable divalent cycloaliphatic groups a1 are substituted or unsubstituted, preferably unsubstituted, cycloalkanediyl radicals having 4 to 20 carbon atoms, such as cyclobutane-1,3-diyl, cyclopentane-1,3-diyl, cyclohexane-1,3- or -1,4-diyl, cycloheptane-1,4-diyl, norbornane-1,4-diyl, adamantane-1,5-diyl, decalindiyl, 3,3,5-trimethylcyclohexane-1,5-diyl, 1-methylcyclohexane-2,6-diyl, dicyclohexylmethane-4,4′-diyl, 1,1′-dicyclohexane-4,4′-diyl or 1,4-dicyclohexylhexane-4,4″-diyl, especially 3,3,5-trimethylcyclohexane-1,5-diyl or dicyclohexylmethane-4,4′-diyl.

In the structural elements A which are composed of at least two groups a1 the at least two groups a1 are linked to one another directly via covalent bonds.

In the structural elements A which contain at least two groups a1 these groups are linked to one another via at least one at least divalent linking functional group a2.

The structural element A and/or the group a1 or the groups a1 may be substituted.

Suitable substituents include all atoms and organic functional groups which are substantially inert, i.e., which do not enter into any reactions with the other functional groups of the compounds of the general formulae Ia and Ib, of the nanoparticles of the invention, and of the new materials produced from them; do not catalyze any unwanted reactions, such as decomposition reactions or premature or crosslinking reactions, of compounds of the general formulae Ia and Ib, of the nanoparticles of the invention, and of the new materials produced from them; and which do not inhibit desired reactions, such as the hydrolysis and condensation of the compounds of the general formulae Ia and Ib or of the new curable materials prepared with the aid of the nanoparticles of the invention.

Examples of suitable inert substituents are halogen atoms, especially fluorine, chlorine and bromine, halogenated alkyl groups, especially trifluoromethyl groups, nitro groups, nitrile groups or alkoxy groups.

Examples of suitable linking functional groups a2 are methylene, ethane-1,1-diyl, propane-2,2-diyl, ether, thioether, tertiary amino, carboxylic ester, thiocarboxylic ester, carbonate, thiocarbonate, phosphoric ester, thiophosphoric ester, phosphonic ester, thiophosphonic ester, phosphite, thiophosphite, sulfonic ester, amide, thioamide, phosphoramide, thiophosphoramide, phosphonamide, thiophosphonamide, sulfonamide, imide, urethane, thiourethane, hydrazide, urea, thiourea, carbonyl, thiocarbonyl, sulfone, sulfoxide, siloxane, isocyanurate, biuret, uretdione, iminooxadiazinedione, carbodiimide or allophanate groups, preferably methylene, propane-2,2-diyl, isocyanurate, biuret, uretdione, iminooxadiazinedione, carbodiimide or allophanate groups.

In the compounds of the general formula Ia the groups a1 of the structural elements A are preferably joined directly via covalent bonds and/or via methylene groups to the nitrogen atoms of the below-described groups X of the general formula II.

In the compounds of the general formula Ib the groups a1 of the structural elements A are preferably linked directly via covalent bonds and/or via methylene groups to the below-described divalent atoms or divalent linking functional groups K and the below-described groups Y of the general formula III.

In the general formulae Ia and Ib the variable B is an at least divalent, preferably divalent or trivalent, softening, flexibilizing structural element which as constituent of three-dimensional networks raises their glass transition temperature.

The softening, flexibilizing structural element B may be substituted by the substituents described above.

The softening, flexibilizing structural element B may include heteroatoms which are inert in the sense specified above. The heteroatoms may be constituents of the above-described linking functional groups a2. The heteroatoms are preferably selected from the group consisting of oxygen, sulfur, and silicon atoms, which in particular are part of ether, thioether, and siloxane groups.

The softening, flexibilizing structural element B preferably comprises at least one group b1 or is composed of at least one group b1 selected from the group consisting of
(i) divalent and polyvalent, substituted and unsubstituted, linear and branched alkanediyl radicals having 4 to 20, preferably 5 to 20, and in particular 6 carbon atoms, which within the carbon chain may also contain cyclic groups, where the carbon chains between the cyclic groups and the groups K and Y of the general formula Ia or the groups X of the general formula Ib each contain more than two carbon atoms;
   examples of highly suitable linear alkanediyl radicals b1 are ethane-1,2-diyl, propane-1,2- and -1,3-diyl, tetramethylene, pentamethylene, hexamethylene, heptamethylene, octamethylene, nonane-1,9-diyl, decane-1,10-diyl, undecane-1,11-diyl, dodecane-1,12-diyl, tridecane-1,13-diyl, tetradecane-1,14-diyl, pentadecane-1,15-diyl, hexadecane-1,16-diyl, heptadecane-1,17-diyl, octadecane-1,18-diyl, nonadecane-1,19-diyl or eicosane-1,20-diyl, preferably tetramethylene, pentamethylene, hexamethylene, heptamethylene, octamethylene, nonane-1,9-diyl, decane-1,10-diyl, preferably ethane-1,2-diyl and propane-1,2- and -1,3-diyl, especially propane-1,3-diyl;
   examples of highly suitable alkanediyl radicals b1 which also include cyclic groups in the carbon chain are 2-heptyl-1-pentylcyclohexane-3,4-bis(non-9-yl), cyclohexane-1,2-, -1,4- or -1,3-bis(eth-2-yl), cyclohexane-1,3-bis(prop-3-yl) or cyclohexane-1,2-, -1,4- or -1,3-bis(but-4-yl);
(ii) divalent polyester radicals b1 having repeating polyester fractions of the formula IV:

—C(O)—(CHR¹)ₛ—CH₂—O—)— (IV),
in which the index s=4 to 6 and the substituent R¹=hydrogen or an alkyl, cycloalkyl or alkoxy radical, no one substituent containing more than 12 carbon atoms;
(iii) divalent linear polyether radicals b1 of the general formula V:

—(—O—(CHR²)ₜ—)ᵤO— (V),
where the substituent R²=hydrogen or a lower, optionally substituted alkyl radical, the index t=2 to 6, preferably 2 to 4, and the index u=2 to 100, preferably 2 to 50;
examples of particularly suitable polyether radicals b1 are linear or branched polyether radicals deriving from poly(oxyethylene) glycols, poly(oxypropylene) glycols, and poly(oxybutylene) glycols;
(iv) divalent linear siloxane radicals b1, preferably siloxane radicals b1 such as are present, for example, in silicone rubbers;
(v) divalent hydrogenated polybutadiene and polyisoprene radicals b1;
(vi) divalent radicals of random or alternating butadiene-isoprene copolymers and butadiene-isoprene graft copolymers b1; and
(vii) divalent radicals of ethylene-propylene-diene copolymers b1.

In the general formulae Ia and Ib the variable D stands for the radical of a blocking agent for isocyanate groups —NCZ, in which Z=oxygen atom or sulfur atom, especially oxygen atom. Preferably the radical D derives from customary, known blocking agents, such as, for example,
(i) phenols such as phenol, cresol, xylenol, nitrophenol, chlorophenol, ethylphenol, tert-butylphenol, hydroxybenzoic acid, esters of this acid or 2,5-di-tert-butyl-4-hydroxytoluene;
(ii) lactams, such as ε-caprolactam, δ-valerolactam, γ-butyrolactam or β-propio-lactam;
(iii) active methylenic compounds, such as diethyl malonate, dimethyl malonate, methyl or ethyl acetoacetate or acetylacetone;
(iv) alcohols such as methanol, ethanol, n-propanol, isopropanol, n-butanol, isobutanol, tert-butanol, n-amyl alcohol, tert-amyl alcohol, lauryl alcohol, ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, propylene glycol monomethyl ether, methoxymethanol, glycolic acid, glycolic esters, lactic acid, lactic esters, methylol urea, methylolmelamine, diacetone alcohol, ethylenechlorohydrin, ethylenebromohydrin, 1,3-dichloro-2-propanol, 1,4-cyclohexyldimethanol or acetocyanohydrin;
(v) mercaptans such as butyl mercaptan, hexyl mercaptan, tert-butyl mercaptan, tert-dodecyl mercaptan, 2-mercaptobenzothiazole, thiophenol, methylthiophenol or ethylthiophenol;
(vi) acid amides such as acetoanilide, acetoanisidinamide, acrylamide, methacrylamide, acetamide, stearamide or benzamide;
(vii) imides such as succinimide, phthalimide or maleimide;
(viii) amines such as diphenylamine, phenylnaphthylamine, xylidine, N-phenylxylidine, carbazole, aniline, naphthylamine, butylamine, dibutylamine or butylphenylamine;
(ix) imidazoles such as imidazole or 2-ethylimidazole;

(x) ureas such as urea, thiourea, ethyleneurea, ethylenethiourea or 1,3-diphenylurea;
(xi) carbamates such as phenyl N-phenylcarbamate or 2-oxazolidone;
(xii) imines such as ethyleneimine;
(xiii) oximes such as acetone oxime, formaldoxime, acetaldoxime, acetoxime, methyl ethyl ketoxime, diisobutyl ketoxime, diacetyl monoxime, benzophenone oxime or chlorohexanone oximes;
(xiv) salts of sulfurous acid such as sodium bisulfite or potassium bisulfite;
(xv) hydroxamic esters such as benzyl methacrylohydroxamate (BMH) or allyl methacrylohydroxamate; or
(xvi) substituted pyrazoles or triazoles.

D derives more preferably from substituted pyrazoles, very preferably dimethylpyrazoles.

In the general formulae Ia and Ib the variable X is a group of the general formula II:

—NH—C(Z)— (II),

in which Z is as defined above and where the nitrogen atom in the general formula Ia is linked to the structural element A and in the general formula Ib is linked to the structural element B. The covalent bond symbolized by the left-hand outer hyphen links the atom or the group K to the carbon atom of the group of the general formula II.

In the general formulae Ia and Ib the variable K stands for a divalent or trivalent atom or divalent or trivalent linking functional group selected from the group consisting of —Z—, —NH—, —NJ-, —N<, —N═, —NH—C(Z)—, —NH[—C(Z)—]₂, —NH—C(Z)—NH—, —NH—C(Z)—Z—, —NH—C(Z)—NH—C(Z)Z—, —Z—N═, —Z—NH—C(Z)— and —NH—C(Z)—NH—N═C<, in which the variable Z is as defined above. The divalent and trivalent linking atoms and functional groups K are preferably selected from the group consisting of —NH—, —NJ- and —N<. In any given compound of the general formula Ia or Ib it is possible for there to be only one kind of atoms or groups K present; preferably there are at least two, especially two, different kinds of atoms and/or groups K.

The variable J is selected from the group consisting of monovalent, substituted and unsubstituted, heteroatom-containing and heteroatom-free, aliphatic, cycloaliphatic, aromatic, aliphatic-cycloaliphatic, aliphatic-aromatic, cycloaliphatic-aromatic and aliphatic-cycloaliphatic-aromatic radicals, either containing divalent linking functional groups or free from such groups. Substituents which are can be used are the inert substituents described above.

As heteroatoms and divalent linking functional groups it is possible to use the above-described groups a2, provided they are inert in the sense specified above in each individual case, something which the skilled worker is able to assess without problems, on the basis of his or her general art knowledge.

Examples of suitable aliphatic, cycloaliphatic, aromatic, aliphatic-cycloaliphatic, aliphatic-aromatic, cycloaliphatic-aromatic, and aliphatic-cycloaliphatic-aromatic radicals J are methyl, ethyl, propyl, isopropyl, n-butyl, isobutyl, sec-butyl, tert-butyl, amyl, hexyl, cyclohexane, phenyl, cyclohexylmethylene, phenylmethylene, 2-phenylethan-1-yl, 2-, 3- or 2-, 3- or 4-methyl-, -ethyl-, -propyl-, -isopropyl-, -n-butyl-, -isobutyl-, -sec-butyl-, -tert-butyl-, -amyl- or -hexyl-cyclohexan-1-yl, 2-, 3- or 4-methyl-, -ethyl-, -propyl-, -isopropyl-, -n-butyl-, -isobutyl-, -sec-butyl-, -tert-butyl-, -amyl- or -hexyl-phen-1-yl, 4-phenylcyclohexan-1-yl, 4-cyclohexanephen-1-yl or (4-phenylcyclohexan-1-yl)methyl.

The variables D, K, and X of the blocked isocyanate groups of the general formula VI:

D-K—X— (VI),

in which these variables are as defined above are preferably selected such that the blocked isocyanate groups have a deblocking temperature of 80 to 180° C., more preferably 80 to 160° C., very preferably 80 to 150° C. and in particular 80 to 150° C.

In the general formulae Ia and Ib the group Y stands for a group of the general formula III:

—SiEᵣF₃₋ᵣ (III).

In the general formula III the index r stands for an integer from 1 to 3, especially 3.

In the general formula III the variable E stands for a hydrolyzable atom, preferably selected from the group consisting of hydrogen atom, fluorine atom, chlorine atom or bromine atom. Additionally the variable E stands for a monovalent hydrolyzable radical, preferably selected from the group consisting of groups of the general formula VII:

-G-J (VII),

in which the variable G comes from the group consisting of —Z—, —C(Z)—, —Z—C(Z)—, —C(Z)—Z—, —NH— or —NJ-, the variables Z and J being as defined above, and the covalent bond symbolized by the left-hand outer hyphen linking the atom or the group G to the silicon atom. In particular the variable J is methyl and ethyl. In particular the variable Z is an oxygen atom.

In the general formula III the variable F stands for a nonhydrolyzable radical. Examples of nonhydrolyzable radicals F are the above-described groups J, it being possible, in one group of the general formula III, for two groups J to be linked cyclically to one another, for example, via a covalent single or double bond or one of the above-described linking functional groups a2 or K.

Examples of particularly suitable compounds of the general formulae Ia and Ib are the compounds below of the formulae Ia1, Ia2, Ib1, and Ib2, especially Ia2.

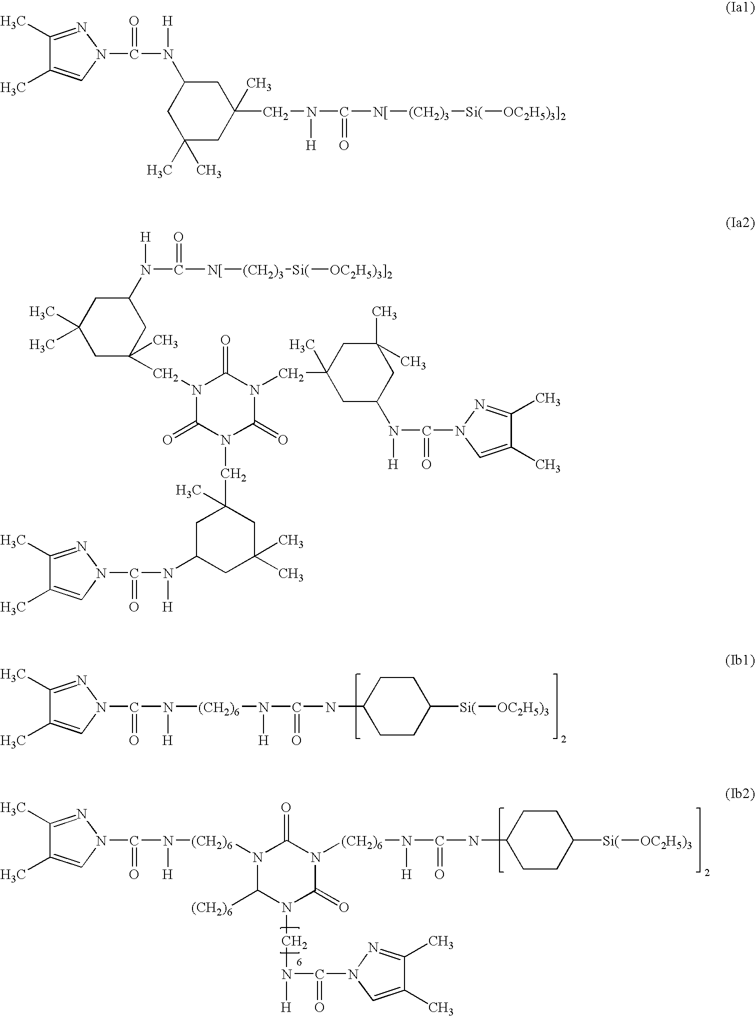

The compounds of the general formulae Ia and Ib can be prepared by the customary, known methods of organic chemistry, particularly those of the organic chemistry of isocyanates and silicon compounds.

The compounds of the general formula Ia are preferably prepared as part of the process of the invention for preparing the nanoparticles of the invention, by reacting at least one, especially one, polyisocyanate of the general formula VIIIa:

A(NCZ)_{m+q} (VIIIa),

with m mol of at least one, especially one, blocking agent of the general formula IX:

D-K—H (IX),

and with q mol of at least one, especially one, compound of the general formula Xb:

H—K[—B(—Y)ₙ]ₚ (Xb),

until free isocyanate groups —NCZ, especially —NCO, are no longer detectable, the customary, known wet-chemical and/or spectroscopic methods preferably being employed for qualitative and quantitative detection of isocyanate groups.

Generally it is the case that in the general formulae (IX) and (Xb) the covalent bond symbolized by the left-hand outer hyphen links the atom or the group K to the hydrogen atom.

In the general formula VIIIa the variables A and Z are as defined above.

In the general formula VIIIa the indices m and q are likewise as defined above; preferably the sum m+q stands for an integer from 2 to 6.

Examples of suitable polyisocyanates of the general formula VIIIa are diisocyanates, such as isophorone diisocyanate (=5-isocyanato-1-isocyanatomethyl-1,3,3-trimethylcyclo-hexane), 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-isocyanato-(4-isocyanatobut-1-yl)-1,3,3-trimethylcyclohexane, 1-isocyanato-2-(3-isocyanatoprop-1-yl)cyclohexane, 1-isocyanato-2-(3-isocyanatoeth-1-yl)cyclohexane, 1-isocyanato-2-(4-isocyanatobut-1-yl)cyclohexane, 1,2-diisocyanatocyclobutane, 1,3-diisocyanatocyclobutane, 1,2-diisocyanatocyclopentane, 1,3-diisocyanatocyclopentane, 1,2-diisocyanatocyclohexane, 1,3-diisocyanatocyclohexane, 1,4-diisocyanatocyclohexane, 1,2-, 1,4- or 1,3-bis(isocyanatomethyl)cyclohexane, dicyclohexylmethane 2,4′-diisocyanate or dicyclohexylmethane 4,4′-diisocyanate, especially isophorone diisocyanate, and also their oligomers. Preference is given to using the oligomers.

Particular preference is given to using oligomers VIIIa which contain isocyanurate, urea, urethane, biuret, uretdione, iminooxadiazinedione, carbodiimide and/or allophanate groups. Examples of suitable preparation processes are known from the patent applications and patents DE 100 05 228 A1, CA 2,163,591 A, U.S. Pat. No. 4,419,513 A, U.S. Pat. No. 4,454,317 A, EP 0 646 608 A, U.S. Pat. No. 4,801,675 A, EP 0 183 976 A1, DE 40 15 155 A1, EP 0 303 150 A1, EP 0 496 208 A1, EP 0 524 500 A1, EP 0 566 037 A1, U.S. Pat. No. 5,258,482 A1, U.S. Pat. No. 5,290,902 A1, EP 0 649 806 A1, DE 42 29 183 A1 or EP 0 531 820 A1.

In particular the isocyanurate of isophorone diisocyanate is used.

In the general formula IX the variables are likewise as defined above. Examples of suitable blocking agents are those described above. It is preferred to use substituted pyrazoles, especially 3,5- or 3,4-dimethylpyrazole.

In the general formula Xb the indices n and p and also the variables K, B, and Y are as defined above.

Examples of suitable compounds of the general formula Xb are known for example from the American patent U.S. Pat. No. 5,998,504 A1, column 3 line 37 to column 4 line 29, or from European patent application EP 1 193 278 A1, page 3 lines 27 to 43.

Preference is given to using 3-aminopropyltrimethoxysilane, 3-aminopropyltriethoxysilane, bis(3-trimethoxysilylpropyl)amine and bis(3-triethoxysilylpropyl)amine, especially bis(3-trimethoxysilylpropyl)amine and bis(3-triethoxysilylpropyl)amine.

Preferably the compounds of the general formula Ia are prepared as part of the process of the invention for preparing the nanoparticles of the invention, by reacting at least one, especially one, polyisocyanate of the general formula VIIIb:

B(NCZ)_{m+q} (VIIIb),

with m mol of at least one, especially one, of the above-described blocking agent of the general formula IX:

D-—K—H (IX),

and with q mol of at least one compound of the general formula Xa:

H—K[-A(—Y)ₙ]ₚ (Xa),

until free isocyanate groups —NCZ, especially —NCO, are no longer detectable, preferably the customary, known wet-chemical and/or spectroscopic methods being employed for qualitative and quantitative detection of isocyanate groups.

Generally it is the case here as well that in the general formulae (IX) and (Xa) the covalent bond symbolized by the left-hand outer hyphen links the atom or the group K to the hydrogen atom.

In the general formula VIIIb the variables A and Z are as defined above.

In the general formula VIIIb the indices m and q likewise are as defined above; preferably the sum m+q stands for an integer from 2 to 6.

Examples of suitable polyisocyanates of the general formula VIIIb are diisocyanates, such as trimethylene diisocyanate, tetramethylene diisocyanate, pentamethylene diisocyanate, hexamethylene diisocyanate, heptamethylene diisocyanate, ethylethylene diisocyanate, trimethylhexane diisocyanate or nonyl triisocyanate (NTI) or acyclic aliphatic diisocyanates containing a cyclic group in their carbon chain, such as diisocyanates derived from dimer fatty acids, such as are sold under the trade name DDI 1410 by Henkel and described in patents WO 97/49745 and WO 97/49747, particularly 2-heptyl-3,4-bis(9-isocyanatononyl)-1-pentylcyclohexane, or 1,2-, 1,4- or 1,3-bis(2-isocyanatoeth-1-yl)cyclohexane, 1,3-bis(3-isocyanatoprop-1-yl)cyclohexane or 1,2-, 1,4- or 1,3-bis(4-isocyanatobut-1-yl)cyclohexane. The latter are included among the acyclic aliphatic diisocyanates VIIIb in the context of the present invention by virtue of their two isocyanate groups attached exclusively to alkyl groups, in spite of their cyclic groups.

Of these diisocyanates, hexamethylene diisocyanate is used with particular preference.

Preference is given to using oligomers of the above-described diisocyanates VIIIb that contain isocyanurate, urea, urethane, biuret, uretdione, iminooxadiazindione, carbodiimide and/or allophanate groups. Examples of suitable preparation processes are known from patent applications and patents DE 100 05 228 A1, CA 2,163,591 A, U.S. Pat. No. 4,419,513 A, U.S. Pat. No. 4,454,317 A, EP 0 646 608 A, U.S. Pat. No. 4,801,675 A, EP 0 183 976 A1, DE 40 15 155 A1, EP 0 303 150 A1, EP 0 496 208 A1, EP 0 524 500 A1, EP 0 566 037 A1, U.S. Pat. No. 5,258,482 A1, U.S. Pat. No. 5,290,902 A1, EP 0 649 806 A1, DE 42 29 183 A1 or EP 0 531 820 A1.

In particular the isocyanurate of hexamethylene diisocyanate is used.

Examples of suitable compounds of the general formula Xa are 4-amino-1-trimethoxysilyl- and -triethoxysilyl-cyclohexane, 4-amino-1-trimethoxysilyl- and -triethoxysilyl-benzene, bis(4-trimethoxysilylcyclohex-1-yl)amine, bis(4-triethoxysilylcyclohex-1-yl)amine, bis(4-tri-methoxysilylphen-1-yl)amine, and bis(4-triethoxysilylphen-1-yl)amine.

Viewed in terms of method, the reaction of the polyisocyanates of the general formula VIIIa or VIIIb with the compounds of the general formulae Xb or Xa and also with the blocking agents of the general formula IX has no peculiarities but can instead be carried out by means of the customary, known methods of organic chemistry and of organosilicon chemistry, in solution or in bulk, taking into consideration the customary, known precautionary measures for the handling of isocyanates. The polyisocyanates of the formulae VIIIa or VIIIb can be reacted first with the blocking agents of the general formulae IX or first with the compounds of the general formulae Xb or Xa, in stages; alternatively they can be reacted in a one-pot reaction with the compounds Xb or Xa and with the blocking agents IX. The reactions can be carried out in the presence of customary, known catalysts for the reactions of polyisocyanates, such as dibutyltin dilaurate or bismuth lactate, for example.

In the context of the process of the invention the preparation of the nanoparticles of the invention from the above-described compounds of the general formulae Ia or Ib, in particular from the compounds of the general formula Ia, takes place by hydrolysis and condensation.

The compounds of the general formulae Ia or Ib can be used in whole or in part in the form of precondensates Ia or Ib, i.e., compounds formed by partial hydrolysis of the compounds of the general formulae Ia or Ib, either alone or in a mixture with minor amounts of other hydrolyzable compounds, such as customary, known alkoxysilanes, for example. “Minor amounts” means here that the amount of other hydrolyzable compounds used is only enough advantageously to vary, but not to characterize, the profile of performance properties of the resultant nanoparticles of the invention.

The hydrolysis and condensation can be carried out if desired in organic solvents, preferably aromatic-free solvents.

For the hydrolysis and condensation the compounds of the general formulae Ia or Ib or the precondensates Ia or Ib, in the desired mixing ratio, are precondensed with water. The amount of water is introduced in a metered fashion in such a way as to prevent local concentration excesses. This is accomplished, for example, by introducing the amount of water into the reaction mixture with the aid of moisture-loaded adsorbents, silica gel or molecular sieves for example, hydrous organic solvents, 80% ethanol for example, or hydrated salts, e.g., CaCl₂×6H₂O. Preferably the precondensation takes place in the presence of a hydrolysis and condensation catalyst.

The hydrolysis and condensation of the compounds of the general formulae Ia or Ib or of the precondensates Ia or Ib is carried out in the presence of an aromatic-free organic solvent, such as an aliphatic alcohol such as methanol, ethanol, propanol, isopropanol or butanol, an ether such as dimethoxyethane, an ester such as dimethyl glycol acetate or methoxypropyl acetate, and/or 2-ethoxyethanol, or a ketone such as acetone or methyl ethyl ketone.

Suitable hydrolysis and condensation catalysts include proton donor or hydroxyl ion donor compounds and amines. Specific examples are organic or inorganic acids, such as hydrochloric acid, sulfuric acid, phosphoric acid, formic acid, acetic acid or trifluoroacetic acid, and organic or inorganic bases such as ammonia, alkali metal or alkaline earth metal hydroxides, e.g., sodium, potassium or calcium hydroxide, and amines soluble in the reaction medium, examples being lower alkylamines or alkanolamines. Particularly preferred in this context are volatile acids and bases, especially hydrochloric acid, acetic acid, ammonia or triethylamine.

The precondensation and/or the condensation is carried out at temperatures of 0 to 100° C. and preferably 20 to 95° C. Advantageously the starting products are initially heated to temperatures of 40 to 80° C., especially 50 to 70° C., and held at these temperatures for a certain time, particularly 0.5 to 10 hours, after which they are heated to temperatures of 80 to 100° C., especially 85 to 95° C.

The resulting suspensions of the nanoparticles of the invention can be used further as they are. In accordance with the invention, however, it is of advantage to isolate the nanoparticles of the invention in the form of solids. For that purpose the suspensions of the nanoparticles of the invention are dried in a customary, known way: for example, by spray drying or freeze drying, where appropriate after the partial or substantial removal of catalyst, of any water still present, of the volatile condensation products and/or of the organic solvents, by filtration and/or distillation, especially azeotropic distillation.

The nanoparticles of the invention can be used in a diversity of ways. For example, they can be used as they are, if desired following the addition of minor amounts of customary, known plastics additives, as thermoplastic materials for the production, for example, of thermoplastic moldings, sheets, coatings, adhesive layers, and seals. Or, following the addition of minor amounts of customary, known additives, such as compounds having at least two isocyanate-reactive functional groups, for example, they can be used as thermally curable materials for producing thermoset moldings, sheets, coatings, adhesive layers, and seals.

With very particular advantage, however, the nanoparticles of the invention are used as new additives or functional additives for innovative thermoplastic and/or curable, especially thermally curable, materials for producing innovative thermoplastic or thermoset moldings, sheets, coatings, adhesive layers, and seals, especially coatings, particularly clearcoats.

In this context it proves to be a very particular advantage of the nanoparticles of the invention that they can be incorporated homogeneously, very effectively and very rapidly, with minimal expenditure of energy, into thermoplastic materials in particular, with the aid of customary, known techniques and apparatus, such as extruders or compounders.

Surprisingly, the nanoparticles of the invention develop their advantageous technical effects in an amount of just 0.1% to 10%, preferably 0.5% to 8%, more preferably 1% to 5%, and in particular 1% to 4% by weight, based in each case on the solids of the thermoplastic and/or thermoset materials of the invention.

For the purposes of the present invention the term “solids” comprehends the sum of all those constituents of a thermoplastic and/or thermally curable material of the invention that make up the thermoplastic or thermoset materials of the invention.

The sheets, moldings, coatings, adhesive layers, and seals of the invention that are produced from the thermoplastic and/or curable materials of the invention are outstandingly suitable for coating, bonding, sealing, wrapping, and packing means of transport, such as aircraft, boats, rail vehicles, motor vehicles, and parts thereof; the interior and exterior of buildings and parts thereof; doors, windows, furniture; hollow glassware; coils; containers and packaging; small industrial parts, such as nuts, bolts, wheel rims or hub caps; electrical components, such as windings (coils, stators, rotors); optical components; mechanical components; and components for white goods, such as radiators, household appliances, refrigerator casings or washing machine casings.

The thermoplastic and/or curable materials of the invention can be present in different forms. For instance, they may be in the form of completely or substantially solvent- and water-free, solid or liquid, especially room-temperature-solid or -liquid materials or in the form of solvent- and/or water-containing suspensions. Preferably the thermoplastic and/or curable materials of the invention are solid at room temperature.

More preferably the solid thermoplastic and/or curable materials of the invention are finely divided powders or granules, very preferably finely divided powders.

With very particular preference the granules and finely divided powders of the invention are dimensionally stable at least up to 30° C., preferably at least 50° C., more preferably at least up to 80° C., and in particular at least up to 120° C.

For the purposes of the present invention “dimensionally stable” means that the granules and finely divided powders of the invention, particularly under the customary, known conditions of their storage and transportation, under the effect of their own weight and/or that of shearing forces, undergo little or no agglomeration, sticking, fusing, caking, filming, breakdown into smaller particles, outgassing and/or decomposition, but instead wholly or substantially wholly preserve their original form.

The finely divided powders of the invention may have any of a very wide variety of three-dimensional forms, as described for example in “Basic Principles of Particle Size Analysis”, technical paper by Alan Rawle, Malvern Instruments, Great Britain, 1993, or in the further references cited below. The finely divided powders of the invention are preferably spherical.

The particle size of the finely divided powders of the invention may vary very widely.

Preferably their particle size as measured by means of the customary, known methods of measuring particle or grain or granule sizes (cf. Ullmann's Encyclopedia of Industrial Chemistry, 1997, 5th Edition on CD-ROM, WILEY-VCH, Weinheim, N.Y., “Particle Size Analysis and Characterization of a Classification Process”; P. Bowen, Journal of Dispersion Science and Technology, vol. 23, No. 5, 2002, pages 631 to 662, “Particle Size Distribution Measurement from Millimeters to Nanometers and from Rods to Platelets”; “Basic Principles of Particle Size Analysis”, technical paper by Alan Rawle, Malvern Instruments, Great Britain, 1993; or Artur Goldschmidt and Hans-Joachim Streitberger, BASF-Handbuch Lackiertechnik, Vincentz Verlag, Hanover, 2002, “2.3.3.1 Kenngröβen des Pigmentes als Rohstoff”, pages 310 to 317, especially FIG. 2.3.53, “Übersicht Über die optimalen Messbereiche verschiedener Partikelgröβnbestimmungen”) and in particular by means of light scattering, laser diffraction, the disc centrifuge, electron microscopy, or sedimentation is in the range from 10 nm to 500 μm, more preferably 100 nm to 250 μm, very preferably 0.5 μm to 150 μm, and in particular 1 μm to 100 μm.

The particle size distribution of the finely divided powders of the invention may likewise vary very widely. Thus the particle size distribution may be comparatively broad or comparatively narrow and may also be monomodal or bimodal or have a higher modality. Preferably the particle size distribution is comparatively narrow and monomodal.

Accordingly the average particle size d₅₀, i.e., the median figure, of the finely divided powders of the invention may likewise vary widely. Preferably it is measured by means of the methods described above. Preferably it is situated within the range from >10 nm to <500 μm, more preferably >100 nm to <250 μm, with particular preference >0.5 μm to <150 μm, and in particular >1 μm to <100 μm.

An example of one particularly advantageous particle size distribution for the finely divided powders of the invention is the particle size distribution described in European patent EP 0 666 779 B1, column 2 line 28 to column 5 line 18, in conjunction with FIG. 2.

It is a particular advantage of the finely divided powders of the invention that they can be used for any of a very wide variety of end uses. With particular preference they are used as innovative powder coating materials, particularly as innovative powder clearcoat materials.

It is, moreover, a very particular advantage of the powder coating materials of the invention that they can have—apart from the nanoparticles of the invention—any of a very wide variety of physical compositions, meaning that they can be optimally adapted to the respective requirements in a simple way. Examples of suitable physical compositions of powder coating materials, especially powder clearcoat materials, are described in detail in European patent EP 0 666 779 B1 or in German patent applications DE 198 50 211 A1, DE 101 26 652 A1, DE 101 20 770 A1, DE 100 27 267 A1, DE 100 27 290 A1 or DE 100 27 292 A1.

These powder coating materials of the invention can in customary, known fashion be prepared, stored, transported, applied, and cured physically, thermally and/or with actinic radiation, especially UV radiation or electron beams, this constituting a further very particular advantage. The apparatus and techniques suitable for these purposes are likewise described in detail in European patent EP 0 666 779 B1 or in German patent applications DE 198 50 211 A1, DE 101 26 652 A1, DE 101 20 770 A1, DE 100 27 267 A1, DE 100 27 290 A1 or DE 100 27 292 A1.

The innovative coatings, especially clearcoats, produced from the powder coating materials of the invention are of particularly high scratch resistance. At the same time they are hard, flexible, chemically resistant, solvent resistant, gasoline resistant, stable to weathering, to etching, and to yellowing, and also to moisture, and exhibit a particularly high distinctiveness of image (DOI) and also outstanding firmness of adhesion to any of a very wide variety of substrates. At the same time they have the so-called automobile quality as is defined for example in European patent EP 0 352 298 B1, page 15 line 42 to page 17 line 40.

The clearcoats of the invention can therefore be employed with very particular advantage as the outermost coats of innovative multicoat color and/or effect paint systems, especially multicoat color and/or optical effect, electrically conductive, magnetically shielding, corrosion inhibiting and/or fluorescent paint systems. The multicoat paint systems of the invention can be produced employing customary, known wet-on-wet techniques and paint systems, as described for example in German patent application DE 199 48 004 A1, page 17 line 37 to page 18 line 2, page 18 lines 36 to 50, and page 18 line 66 to page 19 line 3. The clearcoats of the invention contribute substantially to the outstanding overall appearance of the multicoat paint systems of the invention, and protect their color and/or effect coats outstandingly against mechanical, chemical, and radiation-induced damage.

### Inventive and Comparative Examples

### Preparation Example 1

### The Preparation of Compound Ia2

80.2 parts by weight of a partially blocked and partially—to an extent of about 40%—silanized isophorone diisocyanate trimer according to preparation example 1 of European patent application EP 1 193 278 A1 were combined with 13.97 parts by weight of 3,5-dimethylpyrazole in a three-necked flask equipped with stirrer and internal thermometer. The resulting mixture was heated to 50° C. with stirring. The conversion in the reaction was monitored by means of IR spectroscopy. After 13 hours the blocking reaction was complete, and free isocyanate groups were no longer detectable.

### Preparation Example 2

### The Preparation of Thermoplastic Nanoparticles

69.43 parts by weight of compound Ia2 were admixed with 124.48 parts by weight of isopropanol and 1.71 parts by weight of a 0.1 N aqueous solution of Ethomeen® C 25 (cocoalkylamine ethoxylate from Akzo Nobel). The resulting solution was heated at 70° C. with stirring for three hours. Subsequently 4.38 parts by weight of trimethylethoxysilane were added, after which the batch was stirred at 70° C. for three hours more. Thereafter the volatile solvent constituents and the condensation products were removed in vacuo. After cooling to room temperature, the reaction product was dried in a vacuum drying cabinet at 40° C. for 48 hours in order to remove the solvent completely.

The resultant thermoplastic nanoparticles had a glass transition temperature of 42° C. (determined by means of DSC). They were outstandingly suitable as additives for thermoplastic and/or curable materials.

### Inventive Example 1 and Comparative Example C1

### The Preparation of a Powder Clearcoat 1 Containing Thermoplastic Nanoparticles (Example 1) and of a Nanoparticle-Free Powder Coating Material C1 (Example C1)

To prepare the powder coating material 1 of example 1 and the powder coating material C1 of example C1 the constituents indicated in table 1 were mixed with one another and homogenized by extrusion, after which the resulting mixtures 1 and C1 were subjected to milling. The resultant powders 1 and C1 were classified as described in European patent EP 0 666 779 B1 so as to give in each case the particle size distribution described in FIG. 2 of that patent.

TABLE 1
Physical composition of the powder coating material 1 of example 1
and of the powder coating material C1 of example C1

| | Parts by weight: | |
|---|---|---|
| Constituent | Example 1 | Example C1 |
| epoxy resin (glass transition temperature: | 63.61 | 64.98 |
| 40 to 45° C.; mass-average | | |
| molecular weight: 4000 to 6000 daltons; | | |
| epoxy equivalent weight: 300 to 330) | | |
| dodecanedioic acid | 22.93 | 23.42 |
| thermoplastic nanoparticles from | 1.86 | — |
| preparation example 1 | | |
| commercial antiyellowing agent | 2 | 2 |
| from Siber Hegner | | |
| commercial light stabilizer (CGL 1545 | 2 | 2 |
| FG from Ciba Specialty Chemicals) | | |
| commercial light stabilizer | 1 | 1 |
| (Tinuvin ® 144 from Ciba Specialty | | |
| Chemicals) | | |
| commercial powder coating additive | 0.6 | 0.6 |
| (Troy ® EX 542 from Troy) | | |
| commercial leveling agent | 6 | 6 |
| (Baysilone ® AL 3468 MB from | | |
| Borchers) | | |

Both powder coating materials were outstandingly suitable for producing clearcoats.

### Inventive Example 2 and Comparative Example C2

### The Production of the Clearcoat 2 of Example 2 and of the Clearcoat C2 of Example C2

The clearcoat 2 of example 2 was prepared using the clearcoat material 1 from example 1.

The clearcoat C2 of example C2 was prepared using the clearcoat material C1 from example C1.

To produce the clearcoats 2 and C1 the clearcoat materials 1 and C1 were deposited by means of corona application onto metal test panels, which had been coated with a cathodically deposited and thermally cured electrocoat and with a black basecoat, the clearcoats being deposited in a film thickness such that, after the baking of the applied powder films 2 and C2 at 145° C. for 30 minutes the resulting clearcoats 2 and C2 had a film thickness of 40 μm.

Important performance properties of the clearcoats 2 and C2 are found in table 2.

TABLE 2
Performance properties of the clearcoats 2 and C2 from examples 2
and C1

| | Clearcoat: | |
|---|---|---|
| Property | 2 | C2 |
| Chemical resistance | | |
| (in accordance with BMW method 4 PA-P245 | | |
| specification; test liquid: 36 percent strength | | |
| sulfuric acid) | | |
| first visible changes after minutes | 8 | 5 |
| after application: | | |
| first visible swelling after minutes | 15 | 9 |
| after application: | | |
| first damage after minutes | 30 | 23 |
| after application: | | |
| Gloss | | |
| (20°; DIN 67530; units): | 86 | 85 |
| Scratch resistance | | |
| (Amtec Kistler car wash simulation test, | | |
| cf. T. Klimmasch and T. Engbert, Technologietage, | | |
| Cologne, DFO, Berichtsband 32, | | |
| pages 59 to 66, 1997) | | |
| initial gloss (units): | 86 | 85 |
| gloss after the test (units): | 33 | 27 |
| gloss after the test, with cleaning with wash benzine | 59 | 45 |
| (units): | | |
| Micropenetration hardness | | |
| (30 mN; Fischerscope 100V; Vickers diamond | | |
| pyramid) | | |
| universal hardness (N/mm²) | 127.8 | 131.2 |
| standard deviation | 2.09 | 3.23 |
| relative elastic resilience (%) | 35 | 34.32 |

The results of table 2 underscore the fact that the clearcoat 2 from example 2 was superior in its chemical stability and scratch resistance to the clearcoat C2 from comparative example C2, with otherwise comparable advantageous properties.

1. Thermoplastic nanoparticles with a glass transition temperature of 30 to 120° C., prepared by hydrolysis and condensation of at least one compound selected from the group consisting of compounds of the general formulae Ia and Ib:
(D-K—X—)ₘA{—X—K[—B(—Y)ₙ]ₚ}_{q} (Ia) and
(D-K—X—)ₘB{—X—K[-A(—Y)ₙ]ₚ}_{q} (Ib)
in which the indices and variables are defined as follows:
m is an integer from 1 to 5;
n is an integer from 1 to 3;
P is 1 or 2;
q is an integer from 1 to 5;
A is an at least divalent hardening structural element which as a constituent of three-dimensional networks raises their glass transition temperature;
B is an at least divalent softening, flexibilizing structural element which as a constituent of three-dimensional networks lowers their glass transition temperature;
D is a radical of a blocking agent for isocyanate groups —NCZ, in which Z=oxygen or sulfur atom;
X is a group of the general formula II:
—NH—C(Z)— (II),
in which Z is as defined above and where the nitrogen atom in the general formula Ia is linked to the structural element A and in the general formula Ib is linked to the structural element B;
K is a divalent or trivalent atom or divalent or trivalent linking functional group selected from the group consisting of —Z—, —NH—, —NJ-, —N<, —N═, —NH—C(Z)—, —NH [—C(Z)—]₂, —NH—C(Z)—NH—, —NH—C(Z)—Z—, —NH—C(Z)—NH—C(Z)Z—, —Z—N═, —Z—NH—C(Z)— and —NH—C(Z)—NH—N═C<,
in which the variable Z is as defined above and
the variable J is selected from the group consisting of substituted and unsubstituted, heteroatom-containing and heteroatom-free, aliphatic, cycloaliphatic, aromatic, aliphatic-cycloaliphatic, aliphatic-aromatic, cycloaliphatic-aromatic, and aliphatic-cycloaliphatic-aromatic radicals which contain divalent linking functional groups or are free from such groups,
the covalent bond symbolized by the left-hand outer hyphen linking the atom or the group K to the carbon atom of the group of the general formula II;
Y is a group of the general formula III:
—SiEᵣF_{3-r—} (III),
in which the index and variables are defined as follows:
r is an integer from 1 to 3,
E is a hydrolyzable atom or a monovalent hydrolyzable radical, and
F is a nonhydrolyzable radical.

2. The thermoplastic nanoparticles of claim 1, wherein the glass transition temperature is 30 to 100° C.

3. The thermoplastic nanoparticles of claim 1, wherein m=1 or 2.

4. The thermoplastic nanoparticles claim 1, wherein n=1 or 2.

5. The thermoplastic nanoparticles claim 1, wherein q=1 or 2.

6. The thermoplastic nanoparticles claim 1, wherein the hardening structural element A comprises at least one group a1 selected from the group consisting of divalent and polyvalent, aromatic and cycloaliphatic groups.

7. The thermoplastic nanoparticles claim 1, wherein the softening, flexibilizing structural element B comprises at least one group b1 selected from the group consisting of
(i) divalent and polyvalent, substituted and unsubstituted, linear and branched alkanediyl radicals having 4 to 20 carbon atoms;
(ii) divalent polyester radicals having repeating polyester fractions of the formula IV:
—(—C(O)—(CHR¹)ₛ—CH₂—O—)— (IV),
in which the index s=4 to 6 and the substituent R^{l}=hydrogen or an alkyl, cycloalkyl or alkoxy radical, no one substituent containing more than 12 carbon atoms;
(iii) divalent linear polyether radicals of the general formula V:
—(—O—(CHR²)ₜ—)ᵤO— (V),
where the substituent R²=hydrogen or a lower, optionally substituted alkyl radical, the index t=2 to 6, and the index u=2 to 100;
(iv) divalent linear siloxane radicals;
(v) divalent hydrogenated polybutadiene and polyisoprene radicals;
(vi) divalent radicals of random or alternating butadiene-isoprene copolymers and butadiene-isoprene graft copolymers; and
(vii) divalent radicals of ethylene-propylene-diene copolymers.

8. The thermoplastic nanoparticles claim 1, wherein the blocked isocyanate group of the general formula VI:
D-K—X— (VI),
in which the variables D, K, and X are as defined above, has a deblocking temperature of 80 to 180° C.

9. The thermoplastic nanoparticles claim 1, wherein the index r=3.

10. The thermoplastic nanoparticles claim 1, wherein the hydrolyzable atom E of the group Y of the general formula III is selected from the group consisting of hydrogen atoms, fluorine atoms, chlorine atoms, bromine atoms, and iodine atoms.

11. The thermoplastic nanoparticles claim 1, wherein the monovalent hydrolyzable radical E of the group Y of the general formula (III) is selected from the group consisting of hydroxyl groups and groups of the general formula VII:
-G-J (VII),
in which the variable J is as defined above and the variable G has the following definition:
G is —Z—, —C(Z)—, —Z—C(Z)—, —C(Z)—Z—, —NH— or —NJ-, the variables Z and J being as defined above, and the covalent bond symbolized by the left-hand outer hyphen linking the atom or the group G to the silicon atom.

12. The thermoplastic nanoparticles claim 1, wherein the nonhydrolyzable monovalent radical F of the group Y of the general formula (III) is selected from the group consisting of the radicals J.

13. The thermoplastic nanoparticles claim 1, prepared by hydrolysis and condensation of at least one compound Ia of the general formula Ia.

14. A process for preparing thermoplastic nanoparticles with a glass transition temperature of 30 to 120° C., comprising:
reacting at least one polyisocyanate of the general formula VIIIa:
A(NCZ)_{m+q} (VIIIa),
with m mol of at least one blocking agent of the general formula IX:
D-K—H— (IX),
and with q mol of at least one compound of the general formula (Xb):
H—K[—B(—Y)ₙ]ₚ (Xb),
until free isocyanate groups —NCZ are no longer detectable, to produce a compound of the general formula Ia
(D-K—X—)ₘA{—X—K[—B(—Y)ₙ]ₚ}_{g} (Ia),
reacting at least one polyisocyanate of the general formula VIIIb:
B(NCZ)_{m+q} (VIIIb),
with m mol of at least one blocking agent of the general formula IX:
D-K—H (IX),
and with q mol of at least one compound of the general formula (Xa):
H—K[-A(—Y)ₙ]ₚ— (Xa),
until free isocyanate groups —NCZ are no longer detectable to produce a compound of the general formula Ib
(D-K—X—)ₘB{—X—K[-A(—Y)ₙ]ₚ}_{q} (Ib);
or a combination thereof; and
hydrolyzing and condensing the compound Ia, the compound Ib, or a combination thereof; wherein
m is an integer from 1 to 5;
n is an integer from 1 to 3;
p is 1 or 2;
q is an integer from 1 to 5;
A is an at least divalent hardening structural element which as a constituent of three-dimensional networks raises their glass transition temperature;
B is an at least divalent softening, flexibilizing structural element which as a constituent of three-dimensional networks lowers their glass transition temperature;
D is a radical of a blocking agent for isocyanate groups —NCZ, in which Z=oxygen or sulfur atom;
X is a group of the general formula II:
—NH—C(Z)— (II),
in which Z is as defined above and where the nitrogen atom in the general formula Ia is linked to the structural element A and in the general formula Ib is linked to the structural element B;
K is a divalent or trivalent atom or divalent or trivalent linking functional group selected from the group consisting of —Z—, —NH—, —NJ-, —N<, —N═, —NH—C(Z)—, —NH [—C(Z)—]₂, —NH—C(Z)—NH—, —NH—C(Z)—Z—, —NH—C(Z)—NH—C(Z)Z—, —Z—N═, —Z—NH—C(Z)— and —NH—C(Z)—NH—N═C<,
in which the variable Z is as defined above and
the variable J is selected from the group consisting of substituted and unsubstituted, heteroatom-containing and heteroatom-free, aliphatic, cycloaliphatic, aromatic, aliphatic-cycloaliphatic, aliphatic-aromatic, cycloaliphatic-aromatic, and aliphatic-cycloaliphatic-aromatic radicals which contain divalent linking functional groups or are free from such groups,
the covalent bond symbolized by the left-hand outer hyphen linking the atom or the group K to the carbon atom of the group of the general formula II;
Y is a group of the general formula III:
—SiEᵣF₃₋ᵣ (III),
in which the index and variables are defined as follows:
r is an integer from 1 to 3,
E is a hydrolyzable atom or a monovalent hydrolyzable radical, and
F is a nonhydrolyzable radical.

15. The process of claim 14, wherein the hydrolyzing and condensing is carried out in the presence of a catalyst.

16. Functional additives for thermoplastic materials, curable materials, or a combination thereof, comprising the thermoplastic nanoparticles of claim 1.

17. (canceled)

18. The functional additives of claim 16, wherein the materials are coating materials, adhesives, sealants or precursors of moldings or sheets.

19. The functional additives of claim 18, wherein the materials serve to produce thermoplastic or thermoset moldings, sheets, coatings, adhesive layers or seals.

20. The functional additives of claim 19, wherein the coatings are multicoat color paint systems, multicoat effect paints systems, or multicoat color and effect paint systems.

21. The functional additives of claim 20, wherein the multicoat color paint systems, multicoat effect paint systems, and multicoat color and effect paint systems are produced by means of wet-on-wet techniques.
